(19) United States
(12) Patent Application Publication
(10) Pub. No.: US 2011/0251327 A1
(43) Pub. Date: Oct. 13, 2011

(54) Antistatic White Coating with a Hydroxylated Acrylic Base

(76) Inventors: Stephanie Remaury, Auriac-sur-Vendinelle (FR); Pascale Nabarra, Baziege (FR); Olivier Guillaumon, Saint-Leon (FR); Serge Reymond, Verniolle (FR)

(21) Appl. No.: 13/083,479

(22) Filed: Apr. 8, 2011

(30) Foreign Application Priority Data
Apr. 8, 2010 (FR) 10 52675

(51) Int. Cl. C08K 3/22; C09D 133/04

(52) U.S. Cl. 524/432

(57) ABSTRACT

An antistatic white paint suitable for application on spacecraft notably, based on a binder of the acrylic polymer type.

### CROSS REFERENCE TO RELATED APPLICATION

This application claims the benefit of the filing date of French patent application no. 10 52675, filed on Apr. 8, 2010, which is incorporated herein by reference in its entirety.

### BACKGROUND OF INVENTION

The present invention relates to electrically conducting coatings for anti-static protection of dielectric or metal substrates, notably of spacecraft, and in particular launchers and satellites. These coatings should meet several requirements. First of all, it is important to avoid charge accumulation at the surface. Therefore anti-static paints are sought for avoiding these so-called “flash-over phenomena” (electrostatic discharges at the surface).

Moreover, these coatings should participate in the thermal control of the craft. It is therefore important that the paint be white, in order to allow total reflection of solar radiations and to avoid heating of the craft which may result from this.

Thus, these paints should meet very strict specifications in terms of solar absorption (alpha), of infrared emissivity (epsilon), of surface electric resistance and adherence.

In the FR 2 568 577 application, a pigment of tin oxide doped with antimony oxide is described as well as paints containing it, notably allowing removal of electrostatic charges. Nevertheless said colored pigment should be mixed with a white pigment in order to meet the requirements of low solar absorption. Moreover, this pigment is expensive and no longer meets European environmental standards. A paint based on tin oxide and on antimony oxide is also described in FR 2 668 491. Nevertheless, there again, addition of titanium dioxide is required for making the paint white.

U.S. Pat. No. 3,538,022 describes a method for making zinc oxide doped with aluminum, gallium or indium oxide.

U.S. Pat. No. 5,312,614 also describes the production of a white pigment based on zinc oxide, doped with gallium oxide, said pigment being white and electrically conducting. Nevertheless none of these documents describes a paint containing such a pigment, notably a paint for space applications meeting the aforementioned technical requirements.

### SUMMARY OF INVENTION

Therefore an object of the invention is to provide an antistatic white coating suitable for application onto spacecraft, notably.

According to a first object, the invention therefore relates to a composition comprising a base component comprising at least one pigment based on zinc oxide doped with gallium oxide, a binder of the hydroxylated acrylic polymer type, a solvent of this binder.

Said composition may optionally comprise a hardener component comprising at least one hardener; generally the composition then appears in the form of two separate components (kit).

### DETAILED DESCRIPTION

Said binder may notably be selected from:
hydroxylated acrylic polymers, such as for example ALBERDINGK® AC2597VP and/or MACRYNAL® SM510N
acrylate/polybutadiene polymers or hydroxylated polyester customarily used for coatings. As an illustration, mention may thus be made of the hydroxylated polyesters of the DESMOPHEN® type marketed by Bayer, such as DESMOPHEN 1100 and DESMOPHEN 651.

Generally, the level of hydroxyl functions in the acrylic or acrylate/polybutadiene polymer is comprised between 1 and 10% by weight.

As a solvent, it is possible to use, as an indication, aromatic hydrocarbons (toluene, xylene, styrene, naphtha, etc), aliphatic hydrocarbons (white spirit, gasolines, petroleum, etc.,) ketones (methylethylketone, methylisobutylketone, diacetone, alcohol, etc.), esters (ethyl acetate, methyl acetate, propyl acetate, ethylene glycol acetate, methylene glycol acetate etc.), glycol ethers (ethylglycol, butylglycol, methylene glycol, propylene glycol, etc.), alcohols (ethanol, propanol, methanol, etc.), aliphatic alkanes such as n-heptane and aromatic alkanes, esters, ketones, siloxanes with low molecular weights notably, terpene hydrocarbons (turpentine, etc.), and water. More particularly, mention may be made of water, aliphatic and aromatic alkanes, esters, ketones, siloxanes with low molecular weight and notably hexamethyldisiloxane, octamethyltrisiloxane and octamethylcyclotetrasiloxane.

The binder may be in the form of an emulsion or dispersion in the water or soluble in said organic solvents.

The solvent proportion may range up to 60% by weight of the base component.

The pigment is preferentially zinc oxide (ZnO) doped with Ga₂O₃, generally with 1-2% (by weight) of Ga₂O₃. The pigment according to the invention may be prepared by applying or adapting any methods known per se such as notably by a temperature treatment and under a reducing atmosphere, and notably according to the methods described in U.S. Pat. No. 3,538,022 or U.S. Pat. No. 5,312,614. The ZnO/Ga₂O₃ pigment is generally used in dispersed or milled form.

The pigment may also comprise any other white pigment such as TiO₂, ZnO, in proportions between 0 and 75% by weight.

Said hardener may be selected from the polymers of the polyisocyanate type, customarily used for coatings. As an illustration, mention may be made of polyisocyanates of the aliphatic polyisocyanate resin type, such as those of the DESMODUR® series, notably DESMODUR N75, DESMODUR XP2487/1, etc., marketed by Bayer.

The hardener component may also comprise a solvent.

The hardener component may also comprise a solvent selected from water, hydrocarbons, such as aliphatic and aromatic alkanes, esters, ketones, siloxanes of low molecular weight, and mixtures thereof. More particularly, mention may be made of solvents based on propylene glycol, such as those of the Dowanol® series, marketed by Dow, notably propyleneglycol methylether acetate.

The base component and/or the hardener component may optionally further comprise a catalyst. Said catalyst may be selected from any catalyst used for promoting cold or hot reactions, such as derivatives of tin or cobalt, notably, tin dibutyldiacetate. The catalyst may be comprised in an amount of 0 to 10% by weight of the base component. Generally, the catalyst is added in such an amount that the catalyst:binder (weight) ratio is less than 0.5%, preferentially comprised between 0.1 and 0.2%.

Generally, the compositions according to the invention are such that the pigment:binder ratio is comprised between 1 and 7 (by weight). Preferably, said pigment:binder weight ratio is comprised between 1 and 4, even more preferentially between 1 and 2.

Without however being bound by theory, the inventors have identified that the pigment:binder ratio notably gave the possibility of adjusting the adherence and electric resistance properties of the composition. Thus, when this ratio increases, the adherence of the composition decreases. Conversely, when this ratio decreases, electric resistance increases.

Of course, the compositions of the invention may also comprise in the base and/or the hardener components, any desired adjuvants commonly used in formulations of coatings, of course provided that they do not excessively degrade the aforementioned technical specifications. Thus, for example, mention may be made of flow agents and adjuvants with which the adherence, coverage, drying or preservation performances may notably be improved. Notably, mention may thus be made of the adjuvants of the AEROSIL® type marketed by EVONIK Industries. The proportion of these agents may vary between 0.5 and 25% (by weight) of the total composition.

According to another object, the invention also relates to the method for preparing a composition according to the invention.

The method comprises the preparation of the base component by mixing its constituents on the one hand, and optionally the preparation of the hardener component, by mixing its constituents on the other hand.

According to another object, the present invention also relates to the method for preparing a coating comprising the cross-linking of the base component,
either by mixing the base and hardener components when the composition comprises such a hardener component (the mixing of the base and of the hardener is usually accomplished with manual or mechanical stirring);
or physical drying of the base component, by action of temperature, at a temperature greater than or equal to 40° C.

The type of equipment and the tooling, as well as the shear rate, may be adapted by one skilled in the art according to customary practices in order to obtain a homogeneous dispersion favorable for obtaining a conducting film.

According to another object, the present invention also relates to the coating able to be obtained in this way with said method.

The coating according to the invention notably satisfies the following regulatory specifications required for spacecraft, i.e.:
a solar absorptivity factor a of less than or equal to 0.3;
an infrared emissivity c of more than or equal to 0.8;
a surface electric resistance comprised between 1 and 1,000 MΩ/□ according to the ASTMD 257-97 or -98, -99 standard or ASTM D257-07 standard, as measured at atmospheric pressure or in a primary vacuum (10⁻³ torrs);
an adherence of class 0 or 1 out of 5, preferably 0, according to the NFEN IS02409 standard (classification 30-038);

The paints for satellites should moreover have low degassing in vacuo (ESA ECSS-Q-70-02A standard).

The coatings according to the invention may have a viscosity comprised between AFNOR cut No. 6 10-30 s or AFNOR cut No. 4 10-30 s. They generally have a flow behavior of the Newtonian or thixotropic type.

According to another object, the present invention also relates to the substrates coated with a coating according to the invention. Said substrates are generally any metal or dielectric support requiring such a coating, notably in the aeronautical, aerospace, military fields, photovoltaic, electric and chemical fields.

The coating of the invention may be applied on any kind of substrates such as polyimides, composites of polyimides or of epoxides reinforced with glass fibers, aramide fibers (Kevlar®), carbon fibers, glass fibers, Kapton®, etc., or metals.

For example, mention may thus be made of satellites, launchers or any component of such thereby coated satellites or launchers.

The coatings of the invention may be applied in one or several layers on the substrate to be painted, and their thickness may vary from a few micrometers to a few millimeters depending on the contemplated applications. Generally, the thickness per layer is advantageously comprised between 5 and 250 μm, with a surface electric resistance comprised between 1 and 1,000 MΩ/□.

The application of the coating layer of the invention on a substrate is accomplished as a paint film and may be carried out by manual or automatic mechanical spraying with a paint gun, by a brush, a paintbrush, a stencil or by any other known technique.

If desired or required, a primary adherence layer or any other primary layer may be applied, for example an adherence or anti-corrosion primary layer, before applying the coating of the invention. More particularly, in the case of metal substrates, the adherence and anti-corrosion primaries MAPSIL® P255 red/clear, Alu-D, E′ and MAPSIL®SILICo, marketed by MAP may be applied. In the case of dielectric supports, adherence primaries (MAPSIL®P255 clear, Alu-D, Kapt A and E′ notably marketed by MAP) may be applied advantageously.

The application of the coating may be advantageously achieved with simultaneous drying allowing evaporation of the solvents.

The following examples are given as an illustration and not as a limitation of the present invention.

### EXAMPLE 1

42 g of pigment ZnO/Ga₂O₃, 28 g of water, 4 g of adjuvants (AMP90) are mixed in 21 g of hydroxylated acrylate ALBERDINGK AC2597VP. Moreover, a mixture of 3.75 g of polyisocyanate DESMODUR XP2487/1 in 1.25 g of solvents (DOWANOL® PMA) is prepared.

And then upon application, the two premixes are mixed with mechanical stirring.

### EXAMPLE 2

47 g of pigment ZnO/Ga₂O₃, 23 g of DOWANOL PMA, 8 g of adjuvants (AEROSIL® R 972) are mixed in 12 g of hydroxylated acrylate MACRYNAL SM510N. Moreover, a mixture of 7.5 g of polyisocyanate DESMODUR N75 in 2.5 g of solvents (DOWANOL® PMA) is prepared.

### EXAMPLE 3

The compositions according to the Examples 1 to 2 above were tested for their thickness, adherence, absorptivity, emissivity and surface electric resistance. The results are summarized in the table below:

| | Example 1 | Example 2 |
|---|---|---|
| Paint thickness | 35 μm | 42 μm |
| Adherence | 0/5 | 0/5 |
| αₚ | 0.28 | 0.29 |
| εₙ | 0.89 | 0.89 |
| Rₛ | 20 to 50 MΩ/□ | 20 to 50 MΩ/□ |

1. A composition comprising a base component comprising at least one pigment based on zinc oxide doped with gallium oxide, a binder of the hydroxylated acrylic polymer type, and a solvent of said binder.

2. The composition according to claim 1, further comprising a hardener component comprising at least one hardener.

3. The composition according to claim 1, wherein said binder is selected from the group consisting of:
hydroxylated acrylate polymers,
hydroxylated acrylate/polybutadiene polymers and hydroxylated polyester.

4. The composition according to claim 1, wherein the level of hydroxyl functions in the hydroxylated acrylic polymer is comprised between 1 and 10% by mass.

5. The composition according to claim 1 wherein the at least one pigment comprises zinc oxide (ZnO) doped with Ga₂O₃.

6. The composition according to claim 2 wherein the base component and/or the hardener component further comprises a catalyst.

7. The composition according to claim 2 wherein the at least one hardener is selected from the group consisting of polymers of the polyisocyanate type.

8. The composition according to claim 2 wherein the hardener component further comprises a solvent.

9. The composition according to claim 1 wherein the pigment : binder ratio is between 1 and 7 (by weight).

10. A method for preparing the composition according to claim 2 comprising:
preparing the base component by mixing the at least one pigment, the binder, and the solvent; and
preparing the hardener component by mixing the at least one hardener.

11. A method for preparing a coating comprising:
cross-linking a base component comprising at least one pigment based on zinc oxide doped with gallium oxide, a binder of the hydroxylated acrylic polymer type, and a solvent of said binder.

12. A coating obtained by the method according to claim 11.

13. The coating according to claim 12 wherein the coating has the following characteristics:
a solar absorptivity factor a of less than or equal to 0.3;
an infrared emissivity (c) greater than or equal to 0.8;
a surface electric resistance comprised between 1 and 1,000 MΩ/□ according to the ASTMD 257-97 or -98, -99 or ASTM D257-07 standard, as measured at atmospheric pressure or in a primary vacuum (10⁻³ torrs);
an adherence of class 0 or 1 out of 5 according to the NFEN ISO2409 standard (classification 30-038).

14. A substrate coated with the coating according to claim 12.

15. The substrate according to claim 14 wherein the substrate is selected from the group consisting of satellites, launchers and any component of such satellites or launchers.

16. The composition according to claim 3, wherein the level of hydroxyl functions in the hydroxylated acrylate polymer or the hydroxylated acrylate/polybutadiene polymer is comprised between 1 and 10% by mass.
